(19) United States
(12) Patent Application Publication
(10) Pub. No.: US 2009/0059933 A1
(43) Pub. Date: Mar. 5, 2009

(54) VALIDATING CUSTOMER IN-HOME NETWORK CONNECTIVITY USING MOCA BRIDGE MODE

(75) Inventors: Fung-Chang Huang, Herndon, VA (US); David H. Liu, Herndon, VA (US); John T. Burch, McLean, VA (US); Charles E. Rothrauff, Sterling, VA (US); Guy M. Merritt, Purcellville, VA (US)

Correspondence Address: FITZPATRICK CELLA HARPER & SCINTO, 30 ROCKEFELLER PLAZA, NEW YORK, NY, 10112, US

(73) Assignee: Tellabs Vienna, Inc., Naperville, IL (US)

(21) Appl. No.: 11/845,908

(22) Filed: Aug. 28, 2007

(51) Int. Cl. H04L 12/56

(52) U.S. Cl. 370/401

(57) ABSTRACT

A network terminal includes a bridge to interface the network terminal to a data channel linked to a central office, a first interface of a first type, and a second interface of a second type that is different from the first type of interface. A processor controls the network terminal to route data packets received via the first interface to the data channel via the bridge, when the network terminal is set to operate in a normal mode, and to route data packets received via the first interface to the second interface, when the network terminal is set to operate in a test mode. In an example embodiment, the first interface is an Ethernet interface and the second interface is a MoCA interface.

### BACKGROUND OF THE INVENTION

1. Field of the Invention

The present invention relates to network connectivity testing and, more particularly, to testing network connectivity using a network terminal at a customer's location.

2. Description of the Related Art

With the increasing availability of high bandwidth data channels, it is possible for a service provider to offer multiple services to a customer through a single data channel, such as a single fiber link. For example, services for broadband video, computer data, and voice data (i.e., cable television, high-speed Internet, and telephone) may be bundled together. The data is transmitted over a high-bandwidth channel from a service provider to a network terminal at the customer's home or business. The network terminal then distributes the data to various customer equipment such as computers, set-top boxes, telephones, and the like. This distribution often occurs in whole or in part using an existing customer network, such as an in-home network that uses coaxial cable or Category 5 (Cat5) cable installed during construction of a home.

FIG. 5 shows a typical arrangement for distributing data to a customer using a fiber link in a passive optical network (PON). An optical line terminal (OLT) 10 is located at a central office (CO) 20, which performs switching functions to distribute data to customers within a given area. The data is transmitted over a fiber link 30 from OLT 10 to an optical network terminal (ONT) 40, which is usually located on the outside of the customer's home. If the customer is located in a multi-dwelling unit or an office building, the optical network terminal may be located in a basement or other accessible area. ONT 40 includes a bridge 45 to interface ONT 40 to the fiber link 30. ONT 40 also typically has an Ethernet interface 50, including a connector 55, and a broadband interface 60, including a connector 65. Broadcast video and other data is distributed to the customer's equipment from broadband interface 60 via a broadband home router (BHR) 70 (also referred to as a “gateway”) and an in-home network 80. A typical in-home network 80 may be a local area network (LAN) that uses coaxial cable to connect various customer equipment, such as a set-top box (STB) 85 for interfacing with a television, a laptop 90, and a PC 95. If the laptop, for example, does not include an interface for connecting to a coaxial cable, it may be equipped with an adapter card that enables a coaxial cable connection to an Ethernet port, sometimes called a line interface module (LIM).

Conventionally, a service technician who installs a network terminal at a customer's location does not test the customer's existing in-home network. If the customer experiences service problems, the customer contacts the service provider and the service provider attempts to diagnose the source of the problem. As a first step, the service provider initiates a so-called OAM (Operation, Administration and Maintenance) Loopback test from CO 20. This test allows the service provider to confirm proper operation of the link from OLT 10 to ONT 40, but does not allow the service provider to test the connectivity of the in-home network. If no problem is found with the link between OLT 10 and ONT 40, a technician schedules a service appointment with the customer and visits the customer's home to troubleshoot issues involving the in-home network and associated equipment.

### SUMMARY OF THE INVENTION

According to a one aspect of the present invention, a network terminal is provided that includes a bridge to interface the network terminal to a data channel linked to a central office, a first interface of a first type, and a second interface of a second type that is different from the first type of interface. The network terminal further includes a processor to control the network terminal to route data packets received via the first interface to the data channel via the bridge, when the network terminal is set to operate in a normal mode, and to route data packets received via the first interface to the second interface, when the network terminal is set to operate in a test mode.

According to another aspect of the present invention, there is provided a method of bridging data between different types of interfaces on a network terminal. The method includes receiving data packets input to the network terminal via a first interface of a first type, and determining whether the network terminal is set to operate in a normal mode or a test mode. The method further includes routing the data packets received via the first interface to a data channel linked to a central office, when the network terminal is set to operate in the normal mode, and routing the data packets received via the first interface to a second interface of a second type that is different from the first type of interface, when the network terminal is set to operate in the test mode.

According to yet another aspect of the present invention, a computer program embodied in a computer-readable storage medium is provided. The program includes code to control a network terminal to perform a method of bridging data between different types of interfaces on a network terminal, as described in the preceding paragraph.

According to still another aspect of the present invention, a method of validating network connectivity is provided. The method involves connecting a test device to a first interface on a network terminal, the first interface being of a first type, and connecting a network to a second interface on the network terminal, the second interface being of a second type different from the first type of interface. The method further includes inputting a command to place the network terminal in a test mode, and inputting a command, using the test device, to initiate connectivity testing of the network connected to the second interface.

These and other aspects of the present invention will be described in further detail below, with reference to the accompanying drawings.

### BRIEF DESCRIPTION OF THE DRAWINGS

FIG. 1 illustrates an example embodiment of a network terminal according to the present invention.

FIG. 2 illustrates an example embodiment of a process for bridging data between different types of interfaces on a network terminal according to the present invention.

FIG. 3 further illustrates an example embodiment of a network terminal according to the present invention.

FIG. 4 illustrates an example embodiment of a process for validating network connectivity according to the present invention.

FIG. 5 illustrates a prior art system for distributing data to a customer using a passive optical network.

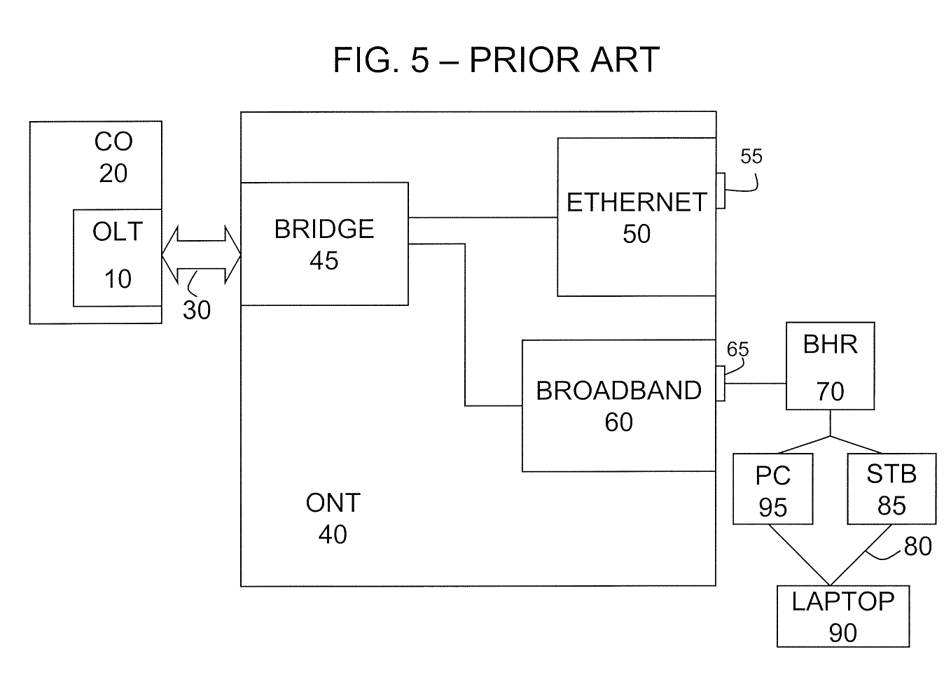

### DETAILED DESCRIPTION

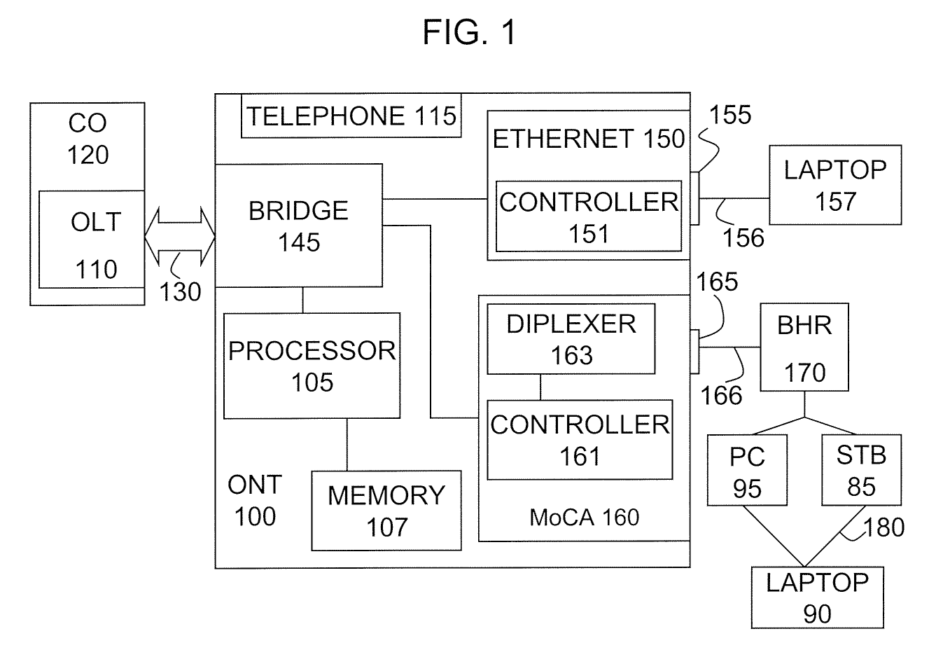

An example embodiment of a network terminal in accordance with the present invention will be described with respect to FIG. 1. As shown in FIG. 1, the network terminal in the example embodiment is an optical network terminal (ONT) 100 and the data channel that delivers information to and from a central office 120 is a fiber link 130. The data channel need not be a fiber link, and the network terminal need not be an optical network terminal. Also, the data channel need not be connected directly to the central office, but instead may be linked to the central office through a relay, repeater, router, switch, or the like.

ONT 100 includes a bridge 145 to interface ONT 100 to the data channel that is linked to the central office, in this example, fiber link 130. The bridge performs necessary functions to route information (e.g., video and/or data) received over fiber link 130 to an appropriate destination interface in ONT 100. These functions may include decoding, adding or removing headers, converting between optical and electrical signals, etc., and these bridge functions are well known in the art. The data channel can also carry data from ONT 100 to CO 120.

ONT 100 also includes at least two types of interfaces to interface ONT 100 to equipment and/or networks at a customer's location. In the example embodiment of FIG. 1, the first type of interface is an Ethernet interface 150. Ethernet is a well-known technology for computer networking, which has been standardized as IEEE 802.3. In the example embodiment of FIG. 1, the second type of interface is a Multimedia over Coax Alliance (MoCA) interface 160, which connects a network terminal to a MoCA LAN network. MoCA is an industry driven initiative to promote standards in delivering video and entertainment information to a customer's equipment via an existing coaxial cable network. The term “MoCA LAN network” as used herein refers to a network that is compliant with at least the MoCA 1.0 MAC/PHY specification. Those skilled in the art will appreciate that the first type of interface is not limited to an Ethernet interface but may also be, for example, an interface to connect a network terminal to a Wi-Fi (IEEE 802.11) network. Similarly, the second type of interface is not limited to a MoCA interface but may also be an interface to connect a network terminal to some other type of network, and in particular may be an interface to connect a network terminal to another type of in-home network or local area network.

As shown in FIG. 1, an Ethernet interface 150 includes an Ethernet controller 151 and an Ethernet port or connector 155. The Ethernet interface performs necessary formatting, buffering, and the like to enable ONT 100 to send data to and receive data from a device over an Ethernet cable 156. The device may be, for example, a laptop computer 157. Ethernet port 155, which provides the physical interface between ONT 100 and Ethernet cable 156, may be an RJ45 connector, for example. Similarly, a MoCA interface 160 includes a MoCA controller 161, a diplexer 163, and a MoCA port or connector 165. MoCA interface 160 performs necessary formatting, buffering, and the like to enable ONT 100 to send data to and retrieve data from a MoCA LAN network 180. Data output from MoCA controller 160 in the downstream direction, toward MoCA LAN network 180, is passed through diplexer 163, which separates video and data streams and may be, for example, a 1-to-2 spreader. Data is communicated from ONT 100 over a cable 166 to a broadband home router (BHR) 170, which distributes the information over the MoCA LAN network. MoCA port 165, which provides the physical interface between ONT 100 and cable 166, may be an F-type connector, for example.

ONT 100 also has a telephone interface 115 to which a headset or buttset may be connected and used to send voice signals or DTMF signals (i.e., tone signals generated by a keypad).

As shown in FIG. 1, ONT 100 also includes a processor 105 for controlling the operations of the network terminal, and memory 107. Memory 107 may include various types of volatile and non-volatile memory, which may be used for various purposes such as storing control programs for processor 105, providing working RAM for operations of processor 105, and providing buffer space for bridge 145, Ethernet controller 151, and MoCA controller 161. Although depicted as a single memory device in FIG. 1, those skilled in the art will appreciate that memory 107 may comprise multiple separate storage memories respectively associated with different processors and/or controllers within ONT 100.

Those skilled in the art will further appreciate that the network terminal of the present invention is not limited to having physical components with a one-to-one correspondence to those shown in FIG. 1. Typically, Ethernet controllers and MoCA controllers are available as separate chipsets, but it is possible to incorporate the various functions of the Ethernet controller, MoCA controller, bridge, processor, etc. into integrated circuits in various ways.

ONT 100 further comprises circuitry and/or program code that causes processor 105 to carry out specific control operations to route data between a first interface (e.g., an Ethernet interface) and a second interface (e.g., a MoCA interface). In the example embodiment of FIG. 1, firmware code stored in a nonvolatile section of memory 107 causes processor 105 to control ONT 100 to perform these control operations.

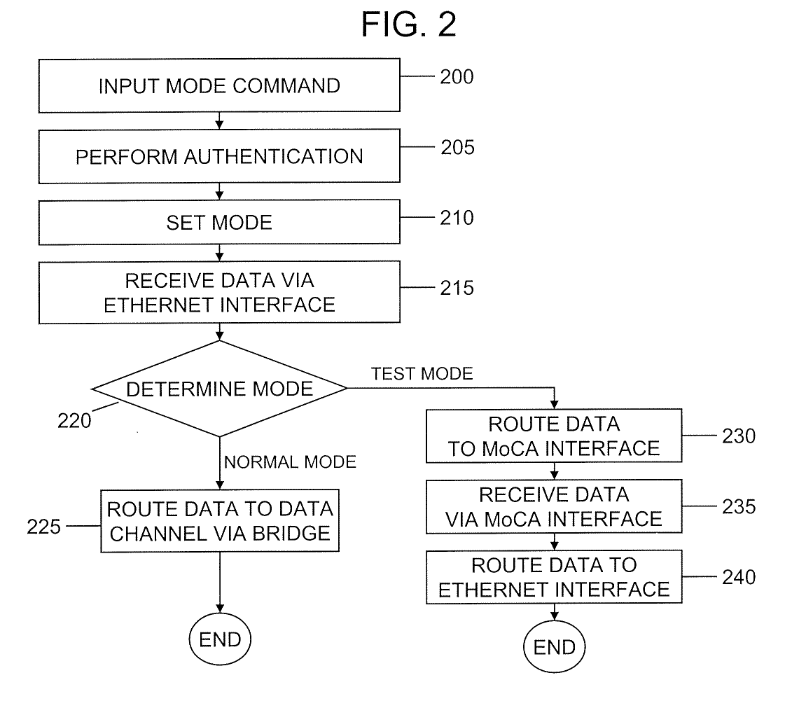

An example embodiment of the control operations performed to route data in accordance with the present invention will be described with reference to FIG. 2. As shown in FIG. 2, in block 200 a mode command is input to the network terminal to specify a normal mode or a test mode. In the example embodiment, since the network connected to the second interface is a MoCA LAN network, the test mode is also referred to as a MoCA bridge mode. The mode command is an appropriate data signal that processor 105 can recognize as a control command instructing ONT 100 either to operate normally or to enter a special MoCA bridge mode for testing. Preferably the normal mode is the default mode, and ONT 100 enters the MoCA bridge mode only when a specific mode command is received to enter that mode.

The mode command can be input to ONT 100 in a variety of ways. For example, the mode command can be input via the Ethernet interface using a test device, such as laptop 157, connected to Ethernet connector 155 via Ethernet cable 156. The mode command may be input by a service technician typing in a command using a touchpad associated with the test device, or a menu of options (or a webpage stored in ONT 100) may be displayed on a display associated with the test device, and the mode command is input by the service technician selecting an option corresponding to the MoCA bridge mode. Alternatively, the mode command can be input as a DTMF signal entered by a service technician using a keypad device connected to telephone interface 115. Yet another way to input the mode command is for a service technician to call the central office on a voice line (for example, using telephone interface 115 or using a separate cell phone) and request entry into the MoCA bridge mode. In response to the request, a mode command can be transmitted to ONT 100 from CO 120 via fiber link 130 and bridge 145.

As shown in block 205, after a mode command is input, authentication may be performed before the network terminal is placed into the test mode. For example, entry of a password may be requested to authenticate that the person entering the mode command is authorized to change the mode setting. If authentication is successful, the mode is set in block 210 in accordance with the input mode command.

In block 215, data is received in ONT 100 via the Ethernet interface. The data may be input via Ethernet connector 155 using a test device, such as laptop 157. Then, in block 220, it is determined whether ONT 100 is operating in a normal mode or a test mode, i.e., a MoCA bridge mode in the example embodiment. This determination may be made, for example, by checking a mode flag. Alternatively, the determination may be based on whether or not a particular utility or subroutine has been launched.

When ONT 100 is operating in the normal mode, data received via the Ethernet interface (i.e., Ethernet connector 155 and Ethernet controller 150) is routed to CO 120. More specifically, the data is routed to the data channel that is linked to CO 120 (fiber link 130, in the example embodiment) via bridge 145, as shown in block 225. This is a conventional operation, in which data input via the Ethernet interface is intended for the central office and ONT 100 performs its normal function of passing data from the customer side to the data channel linked to the central office. Although FIG. 2 shows this branch of the process terminating after block 225, those skilled in the art will appreciate that the process may continue if, for example, there is additional data from the Ethernet interface to be processed or a new mode command is received. Those skilled in the art will appreciate that a change in mode can be processed, for example, as an interrupt routine that returns process flow to block 210 if a new mode command is input.

Referring again to the determination in block 220, when ONT 100 is operating in the test mode (i.e., the MoCA bridge mode), data received via Ethernet interface 150 is routed to MoCA interface 160, as shown in block 230. Thus, in contrast to the normal operating mode, in which data input to the network terminal via an interface is bridged to the data channel linked to the central office, in the MoCA bridge mode the data input via the Ethernet interface is redirected or “bridged” to the MoCA interface.

When ONT 100 has been set to operate in the MoCA bridge mode, the data input via Ethernet connector 155 by a service technician using a test device may include data such as debug commands that perform certain test routines with respect to MoCA LAN network 180. For example, those routines may validate a connection between the MoCA interface and BHR 170, ping all devices connected to MoCA LAN network 180 to verify connectivity, and/or test characteristics of MoCA LAN network 180 such as integrity, throughput, latency, and network attenuation condition.

More specifically, these commands may include known debug and test commands, such as ping, netstat -r, and Telnet, for example. The ping command may be used to check network device connectivity and transmission latency. The netstat -r command may be used to check who is in the network and active routes. The Telnet command may be used to establish a Telnet connection (i.e., an interactive TCP connection) with BHR 170. After such a connection has been established, additional commands may be used, such as clnkstat -a and clinkstta -r, for example. The clnkstat -a command shows the MoCA PHY transmitted and received rates for each node of the MoCA LAN network, as well as its transmitted and received RF power level. The clinkstta -r command may be used to show the status of each node of the MoCA LAN network and its network coordinate role.

Alternatively, the commands to initiate testing of the network connected to the second interface might be input using a test device connected to telephone interface 115.

As shown in block 235, ONT 100 may receive data via the MoCA interface (i.e., data input using MoCA connector 165) while the operating mode is set to the test mode (i.e., MoCA bridge mode). This data is routed to the test device via Ethernet connector 155 as shown in block 240 and is used by the test device to determine the results of testing. FIG. 2 shows that this branch of the process ends after block 240, but the process may return to another block if, for example, there is more data to be processed or a new mode command is received.

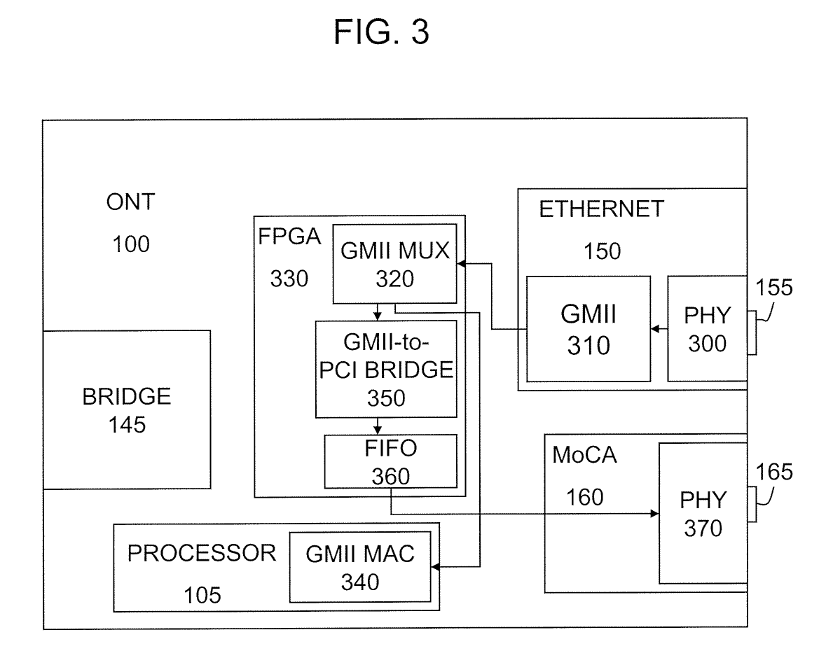

Further details of the operation of ONT 100 in the test mode (in particular, the flow of data packets received via Ethernet interface 150 during operation in the MoCA bridge mode) will be discussed with reference to an example embodiment shown in FIG. 3. In the example embodiment of FIG. 3, ONT 100 includes within Ethernet interface 150 an Ethernet PHY 300, which corresponds to the physical layer in the OSI model and is an interface between a modulated signal and the digital domain, and a gigabit media independent interface (GMII) 310, which in turn is an interface between the physical PHY layer and a media access control (MAC) device. As is known to those skilled in the art, a MAC device is part of the data link layer in the OSI model. Whereas the physical layer merely transfers bits, a MAC device provides addressing and channel access control functions.

The example embodiment of FIG. 3 further includes a field programmable gate array (FPGA) 330 that includes a GMII MUX (multiplexer) 320, a GMII-to-PCI (peripheral component interconnect) bridge 350, and a downstream FIFO 360. PCI is a standard that specifies a computer bus for attaching peripheral components to a computer mother board. As shown in FIG. 3, microcontroller 105 includes a GMII MAC 340, which stores MAC addresses. A MAC address is a quasi-unique identifier associated with a network interface.

MoCA interface 160 in the network terminal includes a MoCA PHY 370, which provides a physical interface to a coaxial cable via MoCA connector 165.

In the normal mode of operation, data packets input to ONT 100 via the Ethernet interface are routed to FPGA 330, and FPGA 330 sends the packets to an Ethernet MAC and then on upstream to the central office via the data link. On the other hand, in the MoCA test mode, FPGA 330 sends the data packets input via the Ethernet interface to the MoCA interface. Thus, FPGA 330 effectively implements a network side loopback function, where data received from the Ethernet interface is “looped” to the MoCA interface, and data received from the MoCA interface is “looped” to the Ethernet interface. No formatting change is required because, at that point in the data path, all packets are in Ethernet frame format.

The flow of data within ONT 100 in the MoCA bridge mode will be discussed with respect to FIG. 3. When operating in the MoCA bridge mode, data packets entering ONT 100 via Ethernet connector 155 are transferred from Ethernet PHY 300, across GMII interface 310, to GMII MUX 320 within FPGA 330. From there, the data travels along two parallel paths. The first path is out of GMII MUX 320, out of FPGA 330 and into GMII MAC 340 within processor 105. After the source MAC address is learned, this data path terminates in bridge 145 upstream of the MAC. If the source MAC address is new, MoCA controller 160 is notified of the new source MAC address.

The second data path is out of GMII MUX 320 and into GMII-to-PCI bridge 350 within FPGA 330. From there, the data packets enter downstream FIFO 360, just as packets coming over a data channel from a central office normally would. The data packets are transferred from FPGA 330 to MoCA PHY 370 using direct memory access (DMA) under the control of MoCA PHY 370, and then MoCA PHY 370 transmits the packets onto the coaxial cable network via MoCA connector 165.

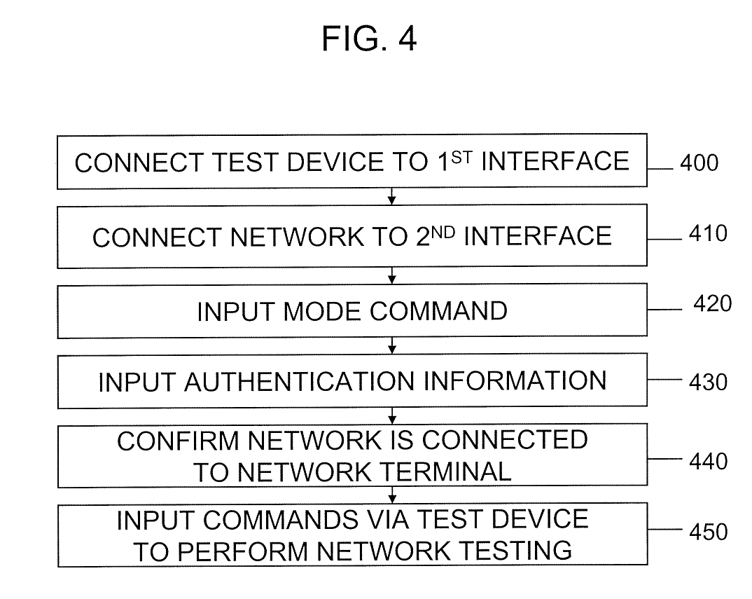

A method to validate connectivity of an in-home network will be discussed with reference to FIG. 4. This method may be performed, for example, by a service technician who performs an initial installation of service provider equipment such as a network terminal, or by a service technician dispatched by the service provider in response to a customer complaint about service.

Referring to FIG. 4, in block 400 the service technician connects a test device to a first interface of the network terminal. For example, the technician may connect laptop computer 157 to Ethernet interface 150 via Ethernet connector 155 on ONT 100. As shown in block 410, the service technician also connects a network to a second interface of the network terminal, which is a different type of interface than the first interface. For example, this may be an in-home coaxial cable network, such as a MoCA LAN network, that is connected to MoCA interface 160 via MoCA connector 165 on ONT 100 and BHR 170.

In block 420, the service technician inputs a mode command to set the network terminal to a test mode that bridges signals between the first and second interfaces. For example, this may be a MoCA bridge mode when a MoCA LAN network is connected to the second interface. The mode command may be input in a variety of ways. For example, the mode command can be input to the first interface using the test device, it can be input using a telephone interface port on the network terminal (for example, by entering DTMF signals using a telephone keypad), or it can be input from a central office, via a data channel to which the network terminal is linked, in response to a request to the central office from the service technician.

In block 430, the service technician performs authentication, if required, such as entering a password or other code to authenticate that the service technician is authorized to place the network terminal in the test mode.

Those skilled in the art will appreciate that no particular order for performing the actions in blocks 400, 410, 420, and 430 is critical. For example, the mode command can be input prior to connecting the network to the second interface port.

Referring again to FIG. 4, in block 440 the service technician may confirm that a network is connected to the second interface, using a command or plural commands input via the first interface using the test device. In block 450, the service technician inputs test commands via the first interface, to initiate desired testing of the network connected to the second interface. Testing may include connectivity, integrity, throughput, and/or latency, for example.

As mentioned above, firmware may be used to control ONT 100 to perform the necessary functions in the MoCA test mode. Program code to control ONT 100 to perform such functions, in the form of firmware or software, may be embodied in a computer readable medium and may be loaded into ONT 100 via a communication link or via a conventional I/O device such as a flash drive, CD drive, floppy disk drive, or other known technique for loading or updating program code in an apparatus.

With the above-discussed method of validating connectivity of an in-home network, a service technician can validate connectivity directly from the customer site after competing the initial installation of equipment. The service technician can confirm that all devices intended to be part of the in-home network appear as network devices and check the signal levels to confirm that there are no signal level problems, such as those caused by having too many signal splitters. Any problems that do exist can be identified and addressed, so that the customer avoids the frustration of subsequently finding that the new service is not working and having to schedule a service appointment. Further, even in the case where this method is performed in response to a customer complaint about service, rather than at the time of initial installation, the service technician can access the network terminal and validate connectivity from outside the customer's home. Thus, initial troubleshooting can be performed without the need to schedule an appointment when the customer must be home to provide inside access to the home.

While the invention has been described above by way of examples and preferred embodiments, those skilled in the art will recognize that there are other variations of the above-embodiments. For example, the network terminal need not be an optical network terminal, the first interface need not be an Ethernet interface, and the second interface need not be a MoCA interface. The network connected to the second interface need not be a coaxial cable network or an in-home network, but rather can encompass other local area networks such as a multiple dwelling unit network or an office network as well.

Other variations and embodiments are also possible. Accordingly the scope of the invention is not intended to be limited to the specific examples and embodiments presented above, but rather should be determined by reference to the claims appended hereto.

We claim:

1. A network terminal comprising:
a bridge to interface the network terminal to a data channel linked to a central office;
a first interface of a first type;
a second interface of a second type that is different from the first type of interface; and
a processor to control the network terminal to route data packets received via the first interface to the data channel via the bridge, when the network terminal is set to operate in a normal mode, and to route data packets received via the first interface to the second interface, when the network terminal is set to operate in a test mode.

2. A network terminal according to claim 1, wherein the first interface is an Ethernet interface and the second interface is a MoCA interface.

3. A network terminal according to claim 2, wherein the processor controls the network terminal to route data packets received via the MoCA interface to the Ethernet interface, when the network terminal is set to operate in the test mode.

4. A network terminal according to claim 3, wherein the processor sets the network terminal to operate in one of the normal mode and the test mode in accordance with a command received via the Ethernet interface.

5. A network terminal according to claim 3, wherein the network terminal further comprises a telephone interface, and the processor sets the network terminal to operate in one of the normal mode and the test mode in accordance with a DTMF signal received via the telephone interface.

6. A network terminal according to claim 3, wherein the processor sets the network terminal to operate in one of the normal mode and the test mode in accordance with a command received from the central office via the data channel and the bridge.

7. A method of bridging data between different types of interfaces on a network terminal, said method comprising:
receiving data packets input to the network terminal via a first interface of a first type;
determining whether the network terminal is set to operate in a normal mode or a test mode;
routing the data packets received via the first interface to a data channel linked to a central office, when the network terminal is set to operate in the normal mode; and
routing the data packets received via the first interface to a second interface of a second type that is different from the first type of interface, when the network terminal is set to operate in the test mode.

8. A method according to claim 7, wherein the first interface is an Ethernet interface and the second interface is a MoCA interface.

9. A method according to claim 8, further comprising:
receiving data packets input to the network terminal via the MoCA interface and routing the data packets received via the MoCA interface to the Ethernet interface, when the network terminal is set to operate in the test mode.

10. A method according to claim 9, further comprising:
setting the network terminal to operate in one of the normal mode and the test mode in accordance with a command received via the Ethernet interface.

11. A method according to claim 9, further comprising:
setting the network terminal to operate in one of the normal mode and the test mode in accordance with a DTMF command received via a telephone interface on the network terminal.

12. A method according to claim 9, further comprising:
setting the network terminal to operate in one of the normal mode and the test mode in accordance with a command received from central office via the bridge.

13. A computer program embodied in a computer-readable storage medium, the program comprising code to control a network terminal to:
receive data packets input to the network terminal via a first interface of a first type;
determine whether the network terminal is set to operate in a normal mode or a test mode;
route the data packets received via the first interface to a data channel linked to a central office, when the network terminal is set to operate in a normal mode; and
route the data packets received via the first interface to a second interface of a second type that is different from the first type of interface, when the network terminal is set to operate in a test mode.

14. A computer program according to claim 13, wherein the first interface is an Ethernet interface and the second interface is a MoCA interface.

15. A computer program according to claim 14, further comprising code to control the network terminal to:
receive data packets input to the network terminal via the MoCA interface; and route the data packets received via the MoCA interface to the Ethernet interface, when the network terminal is set to operate in the test mode.

16. A method of validating network connectivity, comprising:
connecting a test device to a first interface on a network terminal, the first interface being of a first type;
connecting a network to a second interface on the network terminal, the second interface being of a second type different from the first type of interface;
inputting a command to place the network terminal in a test mode; and
inputting a command, using the test device, to perform testing of the network connected to the second interface.

17. A method according to claim 16, wherein connecting the test device comprises connecting the test device to an Ethernet interface on the network terminal, and connecting the network comprises connecting a MoCA LAN network to a MoCA interface on the network terminal.

18. A method according to claim 17, wherein inputting a command to perform testing of the network comprises inputting a command to test connectivity of devices connected to the MoCA LAN network.

19. A method according to claim 17, wherein inputting a command to perform testing of the network comprises inputting a command to test at least one of network integrity, throughput, latency, and attenuation of the MoCA LAN network.

20. A method according to claim 17, wherein the test device is a laptop computer.

21. A method according to claim 17, wherein inputting the command to place the network terminal in the test mode comprises inputting a DTMF command using a telephone interface on the network terminal.

22. A method according to claim 17, wherein inputting the command to place the network terminal in the test mode comprises contacting a central office and requesting that a command be sent to the network terminal from the central office.
